(19) United States
(12) Patent Application Publication
(10) Pub. No.: US 2026/0098591 A1
(43) Pub. Date: Apr. 9, 2026

(54) AUTOMATICALLY SWITCHING A CONTROLLER BETWEEN SNAP OPERATION AND THROTTLE OPERATION

(71) Applicant: ChampionX LLC, Sugar Land, TX (US)

(72) Inventors: Michael Easton, Harrah, OK (US); Sebastian Spivey, Spring, TX (US); Truong Nguyen, Houston, TX (US)

(21) Appl. No.: 19/345,956

(22) Filed: Sep. 30, 2025

Related U.S. Application Data
(60) Provisional application No. 63/704,651, filed on Oct. 8, 2024.

(51) Int. Cl. F16K 31/20; G05D 7/06

(52) U.S. Cl. CPC F16K 31/20; G05D 7/0635

(57) ABSTRACT

A controller and process automatically switch operation of the controller between snap operation and throttle operation based on comparing the controller output signal with setpoints for the respective mode of operation. In snap operation, the controller compares the snap cycle times for each snap cycle and the number of snap cycles with snap operation setpoints to determine when to switch the controller from snap operation to throttle operation. In throttle operation, the controller compares the actual controller output signal with a throttle operation setpoint over a threshold throttle time to determine when to switch the controller from throttle operation to snap operation.

### CROSS REFERENCE TO RELATED APPLICATIONS

This application is a non-provisional patent application claiming the benefit of, and priority to, U.S. Provisional Patent Application No. 63/704,651, filed October 8, 2024, which is incorporated by reference herein in its entirety.

### FIELD OF THE DISCLOSURE

The present disclosure generally relates to controllers, and more particularly, to switching a controller between snap operation and throttle operation.

### BACKGROUND

Controllers are generally coupled with one or more sensors and to equipment, to control equipment based on signal(s) received from the sensor(s). In the context of liquid level in a vessel, liquid level controllers are coupled with one or more liquid level sensors, are configured to determine a level of a fluid in a vessel, and are configured to control equipment based on the signal received from the liquid level sensor(s). Types of liquid level sensors include float or displacer sensors, capacitive sensors, electro-optic sensors, and ultrasonic sensors. The type of sensor used can be based on the type of liquid being monitored and the environment of operation. Sensor selection for appropriate applications is known in the art.

Floats and displacers are a type of fluid motion sensor that rise and fall with a liquid level. Motion sensors have mechanical hardware coupled to the arm, and the position of the sensor in the vessel determines a position of the mechanical hardware. The mechanical hardware interacts with the liquid level controller. The liquid level controller, in turn, has pneumatic or electric hardware that functions to control equipment associated with the vessel, such as an actuated valve that is coupled to an outlet of the vessel. The position of the actuated valve (e.g., open position or closed position) is controlled by the liquid level controller based on a position of the mechanical hardware, which is determined by the position of the sensor in the vessel.

For other types of sensors, components in the sensor detect the liquid level in the vessel and send or change an electric signal to the liquid level controller. The liquid level controller receives the signal or detects the change in the electric signal and controls the actuated valve based on the signal of the sensor.

Liquid level controllers can control the equipment between two positions or states, such as between an on state and an off state or between an open state and a closed state, known as snap-acting. Alternatively, liquid level controllers can be proportionally operated to control the equipment to a percentage that is equal to or between the two positions or states, such as greater than 0% open and less than 100% open for an actuated valve, known as throttle-acting.

Problems can occur when operating a liquid level controller. For example, when operating the liquid level controller in snap mode, high flow rates of liquid into the vessel can cause cycling of the states or positions to become more frequent, shortening the useful life of the equipment, e.g., causes equipment failure. When operating the liquid level controller in throttle-acting mode, low flow rates of liquid into the vessel over long periods of time can cause the liquid level controller to place the equipment in a position or state for periods of time that can shorten the useful life of the equipment. Using an actuated valve as an example of the equipment, for low liquid flow rate into the vessel, the liquid level controller may control the actuated valve at a 10% open position over a long period of time, during which flow rate through the actuated valve can cause damage or erosion to the trim.

There is need to address the shortening of useful equipment life when operating a liquid level controller.

### SUMMARY

A controller for controlling a level of liquid in a vessel, the controller including: a sensor; and a control unit having an electronic circuit board coupled to the sensor, wherein the electronic circuit board is electrically connected to an equipment, wherein the electronic circuit board has a processor and memory with instructions stored thereon which cause the processor to control the equipment based on an electrical signal received from the sensor, wherein the instructions further causes the processor of the electronic circuit board of the control unit to: operate in a snap operation or a throttle operation for control of the equipment; and one or both of: switch from the snap operation to the throttle operation upon determining a setpoint number of consecutive snap cycles for the equipment each have an actual snap cycle time that is less than a threshold snap cycle time, and switch from the throttle operation to the snap operation upon determining an actual controller output signal to the equipment is less than a threshold controller output signal value for a period of time that is equal to or greater than a threshold throttle time.

A process includes controlling, by a controller while in a snap operation, an equipment; and switching, by the controller, from the snap operation to a throttle operation upon determining based on a setpoint number of consecutive snap cycles for the equipment each have an actual snap cycle time that is less than a threshold snap cycle time.

Another process includes controlling, by a controller in a throttle operation, an equipment; and switching, by the controller, from the throttle operation to a snap operation upon determining an actual controller output signal to the equipment is less than a threshold controller output signal value for a period of time that is equal to or greater than a threshold throttle time.

An apparatus includes a vessel, a controller coupled to the vessel, and an equipment fluidly coupled to the vessel and electronically coupled to the controller, wherein the controller includes: a sensor connected to the vessel; and a control unit having an electronic circuit board coupled to the sensor, wherein the electronic circuit board is electrically connected to the equipment, wherein the electronic circuit board has a processor and memory with instructions stored thereon which cause the processor to control the equipment based on an electrical signal received from the sensor, wherein the instructions further causes the processor of the electronic circuit board of the control unit to: operate in a snap operation or a throttle operation for control of the equipment; and one or both of: switch from the snap operation to the throttle operation upon determining a setpoint number of consecutive snap cycles for the equipment each have an actual snap cycle time that is less than a threshold snap cycle time, and switch from the throttle operation to the snap operation upon determining an actual controller output signal to the equipment is less than a threshold controller output signal value for a period of time that is equal to or greater than a threshold throttle time.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1A illustrates a schematic diagram of an apparatus comprising an embodiment of a liquid level controller.

FIG. 1B illustrates a schematic diagram of another apparatus comprising another embodiment of a liquid level controller.

FIG. 2A illustrates graphs of liquid flow rate into a vessel, liquid level in the vessel, and controller output signal versus time, for snap operation of a liquid level controller.

FIG. 2B illustrates graphs of liquid flow rate into a vessel, liquid level in the vessel, and controller output signal versus time, for throttle operation of a liquid level controller.

FIG. 3 illustrates a flowchart of a process for switching a liquid level controller from snap operation to throttle operation.

FIG. 4 illustrates graphs of liquid level in the vessel and controller output signal versus time, for determining when to switch the liquid level controller from snap operation to throttle operation during snap operation of a liquid level controller.

FIG. 5 illustrates a flowchart of a process for switching a liquid level controller from throttle operation to snap operation.

FIG. 6 illustrates graphs of liquid level in the vessel and controller output signal versus time, for determining when to switch the liquid level controller from snap operation to throttle operation during throttle operation of a liquid level controller.

### DETAILED DESCRIPTION

“Snap,” “snap acting,” “snap control,” “snap mode,” and “snap operation” refer to a control mode for a liquid level controller that switches equipment associated with a vessel between two states or positions, such as between on state and off state or between open position and closed position. For example, the equipment can be an actuated valve (also referred to as a valve) fluidly coupled to an outlet of the vessel that is switched between an open position (100% open, 0% closed) and a closed position (0% open, 100% closed) to control a flow of liquid through the actuated valve when a sensor detects a high level liquid in the vessel. In another example, the equipment can be a pump fluidly coupled to an outlet of the vessel that is switched between an on state (running full speed) and an off state (not running) to control the flow of the liquid through the pump when a sensor detects a high liquid level in the vessel. Snap operation can be suitable for low liquid flow rate into the vessel.

“Snap cycle” refers to switching the equipment from a first state or position to a second state or position, and back to the first state or position. For example, a snap cycle for the actuated valve can be switching the actuated valve from closed position to the open position, and back to the closed position; or it can be switching the actuated valve from the open position to the closed position, and back to the open position. A snap cycle for the pump can be switching the pump from off state to on state, and back to off state; or it can be switching the pump from the on state to the off state, and back to the one state.

“Snap cycle time” refers to the amount of time for a snap cycle to occur.

“Throttle,” “throttle acting,” “throttle control,” “throttle mode,” and “throttle operation” refer to a control mode for a liquid level controller, also known in the art as proportional control. For example, a liquid level controller can control an actuated valve one or more intermediate positions that is/are between open position and closed position (position is greater than 0% closed, less than 100% open). Throttle operation can be suitable for high liquid flow rates into a vessel or highly variable liquid flow rates into the vessel.

“Coupled” or “coupled to” is intended to include direct or indirect connection of components references. For example, an actuated valve that is coupled to an outlet of a vessel intends to include within scope an actuated valve directly attached to the outlet of the vessel and an actuated valve that is included in a pipe or line, where the pipe or line is connected directly or indirectly (e.g., via other equipment) to the outlet of the vessel.

To prevent shortening of the useful life of the equipment that is controlled by a controller, the disclosed controller and process automatically switch operation of the controller between a snap operation and a throttle operation. The disclosed controller and process automatically switch operation of the controller between snap operation and throttle operation based on comparing the controller output signal with predetermined setpoints for the respective mode of operation. In snap operation, the controller compares the snap cycle time for each snap cycle and the number of snap cycles with snap operation setpoints to determine when to switch the controller from snap operation to throttle operation. In throttle operation, the controller compares the actual controller output signal with a throttle operation setpoint; and when the controller determines that the actual signal drops below the threshold operation setpoint for a throttle setpoint period of time, the controller switches the controller from throttle operation to snap operation.

For purposes of description, the controller is described as a liquid level controller herein; however, it is contemplated that any controller that is coupled to a sensor and to equipment, whereby the controller uses a signal from the sensor to control the equipment, can utilize the techniques disclosed herein for automatically switch operation of the controller between a snap operation and a throttle operation.

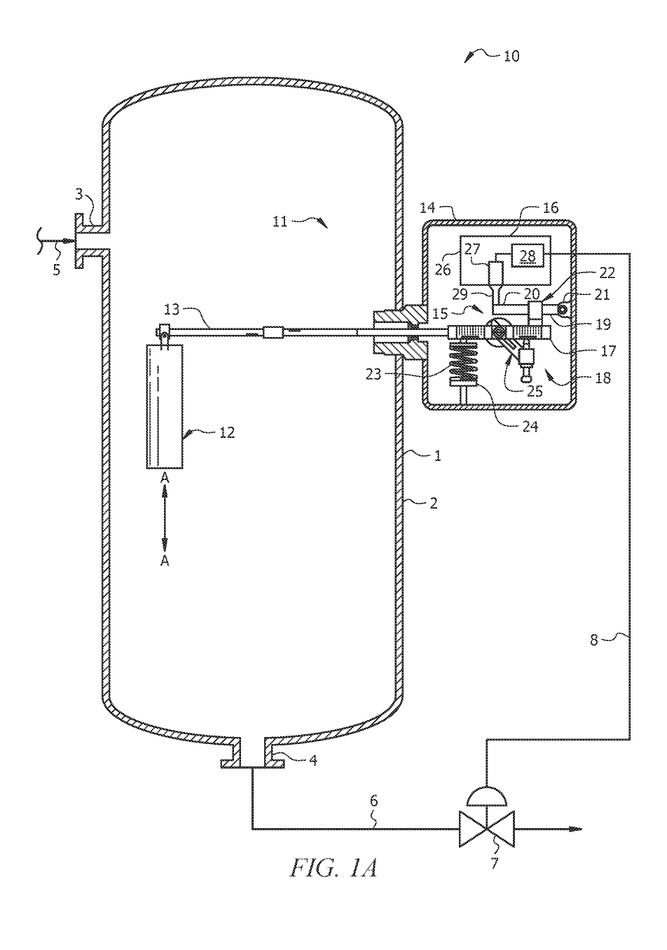

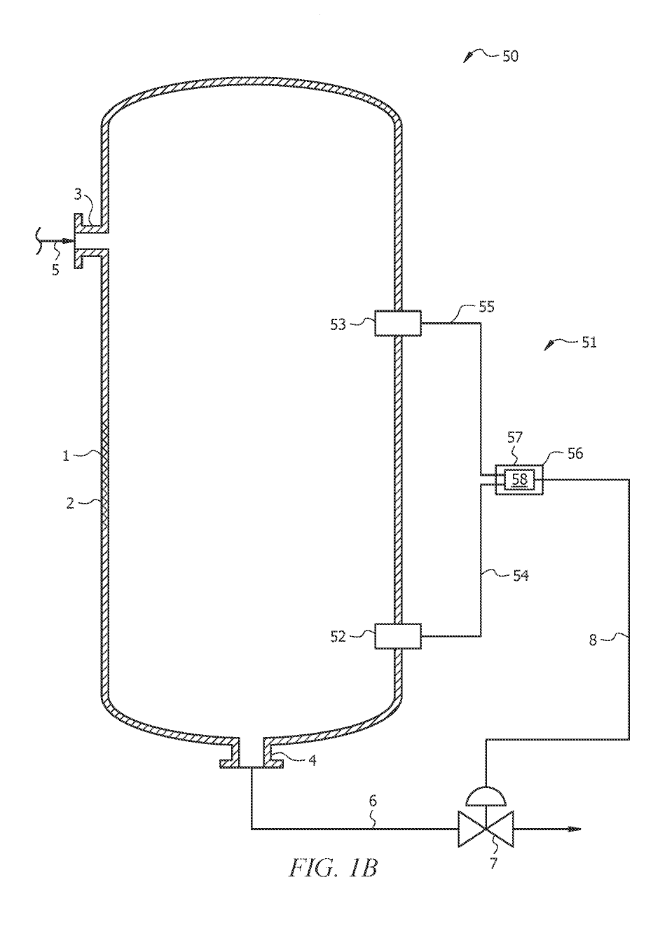

FIG. 1A illustrates a schematic diagram of an apparatus 10 comprising an embodiment of a liquid level controller 11. The apparatus 10 includes a liquid level controller 11 mounted to a side 2 of a vessel 1. The vessel 10 is illustrated in cross-section.

The vessel 1 has at least one inlet (e.g., inlet 3) and at least one outlet (e.g., outlet 4). The inlet 3 is connected to an fluid inlet line 5, and the outlet 5 is connected to a fluid outlet line 6. The inlet 3 is positioned on the side 2 of the vessel 1; however, the inlet 3 can be positioned is another location, such as on a top of the vessel 1. The outlet 4 is positioned on a bottom of the vessel 1; however, it is contemplated that the outlet 4 can be positioned on the side 2 of the vessel 1 (e.g., near the bottom, or on a bottom portion of the vessel 1). The vessel 1 can have a cylindrical shape and be formed of a material known in the art that is compatible with the fluid contained in the vessel 1.

A fluid such as a liquid or slurry (e.g., solids contained in a liquid) can flow from the fluid inlet line 5 into the interior of the vessel 1. The rate of flow of the fluid can be constant or can change over time, or can be both constant for a period of time and transient (change) for another period of time. The fluid can flow from the vessel 1 in fluid outlet line 6. Equipment can be positioned in the fluid outlet line 6 to allow or disallow flow of fluid in the fluid outlet line 6 so as to control a flow of the fluid out of the vessel 1. In FIG. 1A, the equipment is embodied as an actuated valve 7. The actuated valve 7 can be positioned in the fluid outlet line 6 to control the flow of the fluid in the fluid outlet line 6. The actuated valve 7 can be any actuated valve known in the art that is controllably actuatable to a closed position, an open position, or to a position between the closed position and the open position, to allow or disallow the fluid through the actuated valve 7. While the equipment is embodied as actuated valve 7 in FIG. 1A, the equipment can be embodied as another equipment that controls flow of fluid out of the vessel 1, such as a pump that is compatibly manufactured for flowing the fluid (e.g., liquid or slurry). The equipment is operably connected to the liquid level controller 11 by a digital or electrical communication line 8, which can be a wired connection (e.g., copper wires, ethernet cable, coaxial cable, or combinations thereof) or wireless connection (e.g., Wi-Fi, Bluetooth, or combinations thereof). In aspects, the communication line 8 can be an electrical line that sends a controller output signal in the form a 12V or 24V signal having two different amperages that represent an on state and off state or an open position and a closed position (e.g., 4mA or 20mA, or any other combination of amperages). In alternative aspects, such as for wireless communication, the controller output signals representing the state or position of the equipment can be different frequency wireless signals, for example.

Liquid level controller 11 is embodied in FIG. 1A as a float-type liquid level controller; however, it is contemplated that the liquid level controller can be embodied as another type of liquid level controller. In FIG. 1A, the liquid level controller 11 includes a displacer 12, an arm 13, a housing 14, a force balance assembly 15, and a control unit 16. Collectively, the components that convert the liquid level in the vessel 1 into an electrical signal for the control unit 16 can be referred to as the sensor of the liquid level controller 11, e.g., the displacer 12, arm 13, force balance assembly 15, and load cell 27 can be referred to herein as a float-type sensor that is coupled to the electronic circuit board 28 of the control unit 16. In aspects, the liquid level controller 11 does not operate pneumatically, in that, the sensor does not send a pneumatic signal to the control unit 16, the control unit 16 does not send a pneumatic signal to the actuated valve 7, or both.

The displacer 12 is positioned inside the vessel 1. The displacer 12 has density such that the at least a portion of the displacer 12 floats on top of the fluid (e.g., liquid or slurry) that is inside the vessel 1. The displacer 12 moves vertically up or down in the direction of arrow A-A with the level of the level of the fluid in the vessel 1.

The arm 13 has an end coupled to the displacer 12 inside the vessel 1 and an opposite end extending outside the vessel 1 into the housing 14 of the liquid level controller 11. The housing 14 is illustrated in cross-section and can be constructed of any material known in the art with the aid of this disclosure and connected to the side 2 of the vessel 1 by any technique known in the art with aid of this disclosure, such as by threaded connection. In the housing 14, the opposite end of the arm 13 is connected to a force balance assembly 15.

The force balance assembly 15 can be configured to mechanically communicate a movement of the displacer 12 as a pressure force against the control unit 16. For example, the force balance assembly 15 can include a torque bar 17 connected to the opposite end of the arm 13, a linkage assembly 18 connected to the torque bar 17, and a tangent arm 19 coupled to the linkage assembly 18. The linkage assembly 18 can include a balance spring 23, an adjusting knob 24, and a level adjusting bar 25. The balance spring 23 is coupled to the housing 14 and contacts the torque bar 17 proximate an end of the torque bar 17. The adjusting know 24 is turned to adjust the tension of the balance spring 23 against the torque bar 17. The level adjusting bar 25 is coupled to the housing 14 and contacts the torque bar 17 proximate an opposite end of the torque bar 17. An end 20 of the tangent arm 19 can contact the control unit 16 so as to communicate the pressure force that represents the vertical position of the displacer 12, and thus the fluid level (liquid level) inside the vessel 1. An opposite end 21 of the tangent arm 19 can be pivotally connected to the housing 14. The tangent arm 19 can extend through a sensitivity fulcrum 22, which can be moved laterally on the tangent arm 19 to adjust the sensitivity of the force balance assembly 15. Components of the force balance assembly 15 are adjustable for a particular application, such as the tension of the balance spring 23 being adjusted with the adjusting knob 24 and the height of the level adjusting bar 25 being set for a particular tension suitable for the liquid for which the level is being measured, and/or, such as the lateral position of the sensitivity fulcrum 22 being set on the tangent arm 19 to a sensitivity that is suitable for the liquid for which the level is being measured.

The control unit 16 is positioned inside the housing 14 of the liquid level controller 11. The control unit 16 can include a switch housing 26 that contains a load cell 27 and an electronic circuit board 28 that is electrically connected to the load cell 27 and to the equipment that is controlled by the control unit 16 (e.g., the actuated valve 7 in FIG. 1A). The load cell 27 includes or is in contact with an input pin 29 that contacts the end 20 of the tangent arm 19 of the force balance assembly 15. The pressure force is communicated from the tangent arm 19 to the input pin 29 and into the load cell 27. The load cell 27 converts the pressure force received from the input pin 29 to an electrical signal that is received by the electronic circuit board 28. The electronic circuit board 28 has a processor and memory with instructions stored thereon which cause the processor to control the equipment (e.g., actuated valve 7) based on an electrical signal received at the electronic circuit board from the load cell 27. The equipment is controlled by a controller output signal that is communicated from the electronic circuit board 58 to the equipment via communication line 8.

In aspects, the instructions of the electronic circuit board 28 cause the liquid level controller 11 to operate in a snap operation or a throttle operation as is known in the art with the aid of this disclosure. In additional aspects, the instructions of the electronic circuit board 28 can cause the processor to automatically switch operation of the liquid level controller 11 between the snap operation and the throttle operation as is described in more detail herein.

FIG. 1B illustrates a schematic diagram of another apparatus 50 comprising another embodiment of a liquid level controller 51. The apparatus 50 includes the liquid level controller 51 having sensors 52 and 53 mounted to a side 2 of a vessel 1 and control unit 56.

The vessel 1, fluid inlet line 5, fluid outlet line 6, and equipment (embodied as actuated valve 7) in FIG. 1B are the same as described for FIG. 1A, and the description is not reproduced.

The liquid level controller 51 has a low fluid level sensor 52, a high fluid level sensor 53, and a control unit 56. The sensors 52 and 53 are configured to convert the liquid level in the vessel 1 into an electrical signal that is received by the control unit 56. In aspects, the liquid level controller 51 does not operate pneumatically, in that, the sensors 52 and 53 do not send a pneumatic signal to the control unit 56, the control unit 56 does not send a pneumatic signal to the actuated valve 7, or both.

The low fluid level sensor 52 is connected to the side 2 of the vessel 1, and the high fluid level sensor 53 connected to the side 2 of the vessel 1 at a height that is greater than the height for the low fluid level sensor 52. Each of the low fluid level sensor 52 and high fluid level sensor 53 can be embodied as any type of liquid level sensor known in the art with the aid of this disclosure, such as capacitive sensors, electro-optic sensors, or ultrasonic sensors. In aspects, the low fluid level sensor 52 can send a signal to the control unit 56 in the absence of detecting fluid, indicating a low level of fluid in the vessel 1. In aspects, the high fluid level sensor 53 can send a signal to the control unit 56 upon detecting a presence of fluid, indicating a high level of fluid in the vessel 1.

The low fluid level sensor 52 is operably connected to the control unit 56 via a digital or electrical communication line 54, which can be a wired connection (e.g., copper wires, ethernet cable, coaxial cable, or combinations thereof) or wireless connection (e.g., Wi-Fi, Bluetooth, or combinations thereof).

The high fluid level sensor 53 is operably connected to the control unit 56 via a digital or electrical communication line 55, which can be a wired connection (e.g., copper wires, ethernet cable, coaxial cable, or combinations thereof) or wireless connection (e.g., Wi-Fi, Bluetooth, or combinations thereof).

The control unit 56 has a housing 57 that contains electronic circuit board 58. The electronic circuit board 58 is exemplary of a multi-channel input circuit board, in FIG. 1B having two input channels: a first input channel for the low fluid level signal from the low fluid level sensor 52 and a second input channel for the high fluid level signal from the high fluid level sensor 53.

The electronic circuit board 58 has a processor and memory with instructions stored thereon which cause the processor to control the equipment (e.g., actuated valve 7) based on the sensor signals received at the electronic circuit board from the low level fluid sensor 52, the high level fluid sensor 53, or both sensors 52 and 53. The equipment is controlled by a controller output signal that is communicated from the electronic circuit board 58 to the equipment via communication line 8.

In aspects, the instructions of the electronic circuit board 58 cause the liquid level controller 51 to operate in a snap operation or a throttle operation as is known in the art with the aid of this disclosure. In additional aspects, the instructions of the electronic circuit board 58 can cause the processor to automatically switch the mode of operation of the liquid level controller 51 between the snap operation and the throttle operation as is described in more detail herein.

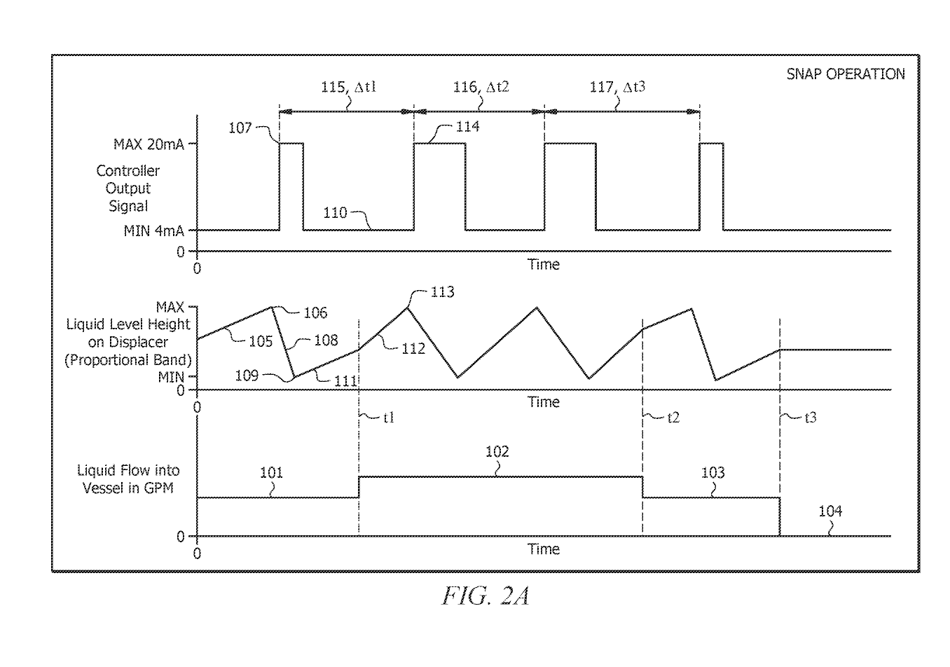

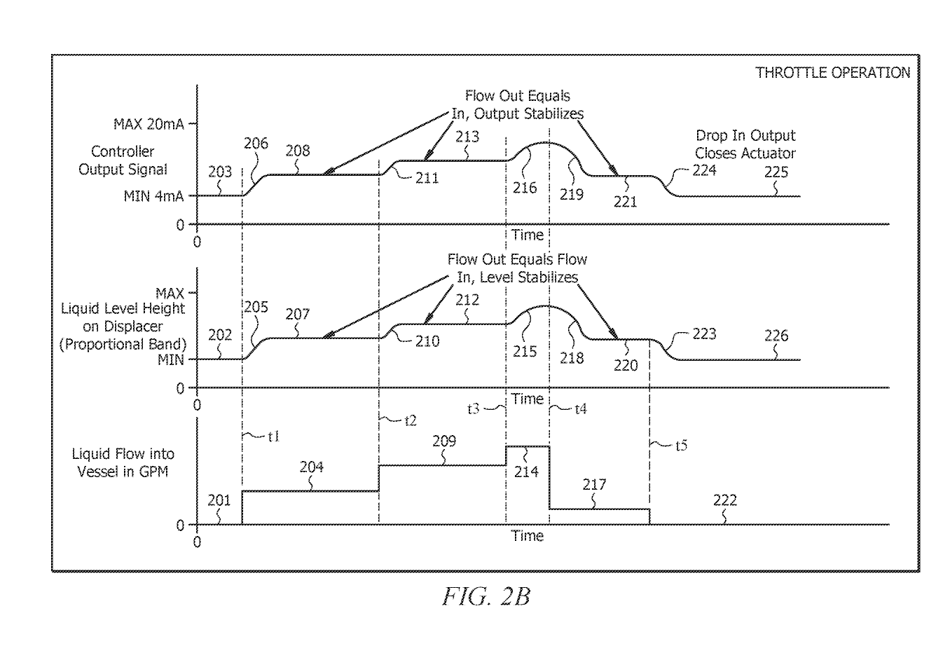

FIGS. 2A, 2B, 3, 4, 5 and 6 are described with respect to a liquid level controller 11 having a displacer 12 that moves vertically up and down with liquid level in the vessel 1 and that controls an actuated valve 7 between an open position and a closed position as described in FIG. 1A. However, it is contemplated that the embodiments, features, and techniques described for FIGS. 2A, 2B, 3, 4, 5, and 6 can apply to other apparatus configurations, such as the liquid level controller 51 in FIG. 1B, such as where the equipment is a pump, such as where the fluid is a slurry, or combinations thereof.

FIG. 2A illustrates graphs of liquid flow rate into the vessel 1, height of displacer 12 (which indicates liquid level) in the vessel 1, and controller output signal versus time, for snap operation of the liquid level controller 11.

At time zero, there is no flow of liquid into the vessel, no liquid is in the vessel 1, and the controller output signal of the liquid level controller 11 to the actuated valve 7 is the signal for closed position of the actuated valve 7 (e.g., 4mA controller output signal).

After time begins, liquid enters the vessel 1 via the inlet 3 and liquid inlet line 5 at a first flow rate that is represented by a horizontal line 101. In response the liquid flowing at the first flow rate indicated by horizontal line 101, the liquid level in the vessel 1 increases, indicated by the upward vertical movement of the displacer 12 by line 105 having a constant slope. The displacer 12 moves vertically upward until the maximum height setpoint is reached at point 106. At the time at when point 106 occurs, the control unit 16 receives the displacer height maximum signal from the load cell 27 and outputs a control output signal 107 (e.g., a 20 mA signal) that changes the actuated valve 7 from the closed position to the open position. The liquid flows out of the vessel 1 indicated by the downward vertical movement of the displacer 12 by line 108 having constant slope. The displacer 12 moves vertically downward until the minimum height setpoint is reached at point 109. At the time at when point 109 occurs, the control unit 16 receives the displacer height minimum signal from the load cell 27 and outputs a controller output signal 110 (e.g., a 4 mA signal) that changes the actuated valve 7 from the open position to the closed position. After the actuated valve 7 is actuated to the closed position, the displacer 12 moves vertically upward, indicated by the upward vertical movement of the displacer 12 by line 111 having a constant slope. At time t1, the liquid flow rate increases from the first flow rate to the second flow rate. In response, the displacer 12 moves vertically upward, indicated by the upward vertical movement of the displacer 12 by line 112 having a constant slope. The displacer 12 moves vertically upward while the controller output signal 110 remains constant until the maximum height setpoint is reached at point 113. At the time at when point 113 occurs, the control unit 16 receives the displacer height maximum signal from the load cell 27 and outputs a controller output signal 114 (also referred to as a maximum controller output signal; e.g., a 20 mA signal) that changes the actuated valve 7 from the closed position to the open position. This completes a first snap cycle 115. The snap cycle time is labeled as Δt1 in FIG. 2A.

The process repeats for a second snap cycle 116 and a third snap cycle 117 illustrated in FIG. 2A. The second snap cycle 116 has a snap cycle time labeled as Δt2, and the third snap cycle 117 has a snap cycle time labeled as Δt3. The snap cycle times Δt1, Δt2, and Δt2 of snap cycles 115, 116, and 117 are tracked by the liquid level controller 11 based on a second liquid flow rate indicated by horizontal line 102 between times t1 and t2, for a third liquid flow rate indicated by horizontal line 103 between times t2 and t3, and for a fourth liquid flow rate (which is zero) indicated by horizontal line 104 after time t4. The second snap cycle 116 is shorter in length of time than the first snap cycle 115 and the third snap cycle 117.

FIG. 2B illustrates graphs of liquid flow rate into the vessel 1, height of displacer 12 (which indicates liquid level) in the vessel 1, and controller output signal versus time, for throttle operation of the liquid level controller 11. The graphs start with a liquid flow rate of zero into the vessel 1, indicated by horizonal line 201. The corresponding height of the displacer 12 is at the minimum height setpoint, indicated by horizontal line 202. The corresponding controller output signal is the minimum value (also referred to as a minimum controller output signal; e.g., 4mA signal), indicated by horizontal line 203.

At time t1, the flow rate of liquid into the vessel 1 increases to a first flow rate, indicated by horizontal line 204. In response, the displacer 12 moves vertically upward with the liquid level in the vessel 1, indicated by the curve of controller output signal 205. The controller output signal correspondingly changes with the height of the displacer 12, indicated by the curve of controller output signal 206. The change in controller output signal changes the actuated valve 7 from the closed position to a first intermediate position (partially open, less than 100% open position) that is proportional to the change in height of the displacer 12. In aspects the controller output signal 206 changes until the flow rate of liquid out of the vessel 1 equals the flow rate of liquid into the vessel 1, e.g., the flow of liquid is steady state. At steady state, the liquid level becomes constant, indicated by the horizontal line 207. The controller output signal also becomes constant at steady state, indicated by horizontal line 208.

At time t2, the flow rate of liquid into the vessel 1 increases to a second flow rate, indicated by horizontal line 209. In response, the displacer 12 moves vertically upward with the liquid level in the vessel 1, indicated by curve of the controller output signal 210. The controller output signal correspondingly changes with the height of the displacer 12, indicated by curve of the controller output signal 211. The change in controller output signal changes the actuated valve 7 from the first intermediate position to a second intermediate position (still partially open, less than 100% open position) that is proportional to the change in height of the displacer 12. In aspects, the controller output signal 211 changes until the flow rate of liquid out of the vessel 1 equals the flow rate of liquid into the vessel 1, e.g., the flow of liquid is steady state. At steady state, the liquid level becomes constant, indicated by the horizontal line 212. The controller output signal also becomes constant at steady state, indicated by horizontal line 213.

At time t3, the flow rate of liquid into the vessel 1 increases to a third flow rate, indicated by horizontal line 214. In response, the displacer 12 moves vertically upward with the liquid level in the vessel 1, indicated by curve of the controller output signal 215. The controller output signal correspondingly changes with the height of the displacer 12, indicated by curve of the controller output signal 216. The change in controller output signal changes the actuated valve 7 from the second intermediate position to a third intermediate position (still partially open, less than 100% open position) that is proportional to the change in height of the displacer 12. The response after time t3 does not have enough time to reach steady state before liquid flow rate into the vessel 1 decreases at time t4.

At time t4, the flow rate of liquid into the vessel 1 decreases to a fourth flow rate, indicated by horizontal line 217. In response, the displacer 12 moves vertically downward with the liquid level in the vessel 1, indicated by curve of the controller output signal 218. The controller output signal correspondingly changes with the height of the displacer 12, indicated by curve of the controller output signal 219. The change in controller output signal changes the actuated valve 7 from the third intermediate position to a fourth intermediate position (still partially open, less % open than the third intermediate position) that is proportional to the change in height of the displacer 12. In aspects, the controller output signal 218 changes until the flow rate of liquid out of the vessel 1 equals the flow rate of liquid into the vessel 1, e.g., the flow of liquid is steady state. At steady state, the liquid level becomes constant, indicated by the horizontal line 220. The controller output signal also becomes constant at steady state, indicated by horizontal line 221.

At time t5, the flow rate of liquid into the vessel 1 again decreases to a fifth flow rate, indicated by horizontal line 222. In response, the displacer 12 moves vertically downward with the liquid level in the vessel 1, indicated by curve of the controller output signal 223. The controller output signal correspondingly changes with the height of the displacer 12, indicated by curve of the controller output signal 224. The change in controller output signal changes the actuated valve 7 from the fourth intermediate position to the closed position because the change in height of the displacer 12 is to the minimum height setpoint. In aspects, the controller output signal 224 changes until the minimum controller value is reached (e.g., 4 mA), after which the controller output signal remains constant since no liquid is flowing into the vessel 1, indicated by horizontal line 225. The height of the displacer 12 also changes until the minimum height setpoint is reached, indicated by horizontal line

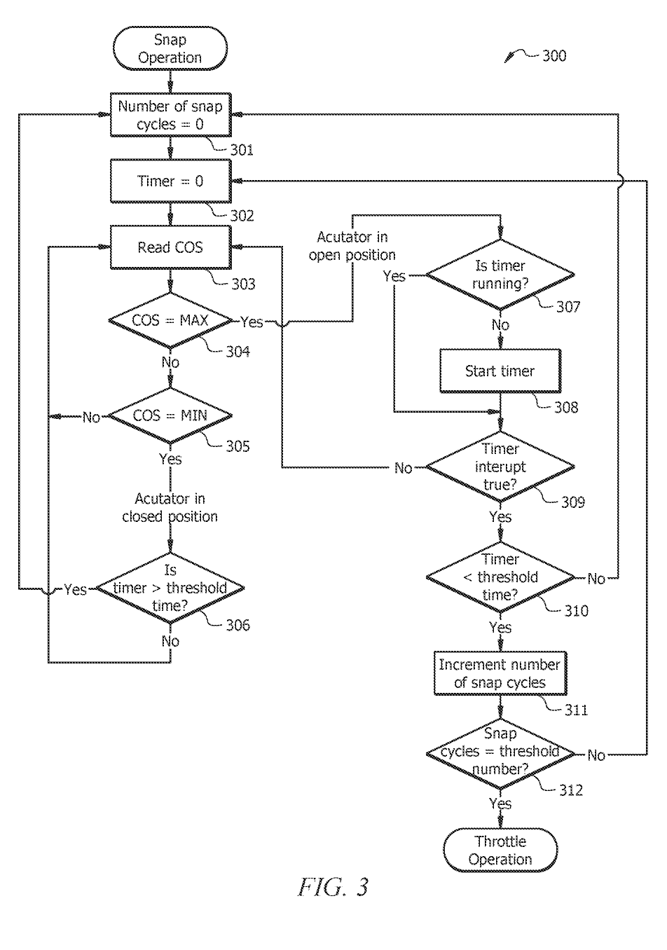

FIG. 3 illustrates a flowchart for a process 300 of switching a liquid level controller 11 from snap operation to throttle operation. To perform the process 300, the liquid level controller 11 is operable to read the controller output signal (e.g., via an analog to digital converter of the controller 11), track the number of snap cycles that occurs over time, keep track of time with a timer function, and analyze the controller output signal versus stored minimum and maximum values for the controller output signal versus time. The process 300 takes place while the liquid level controller 11 is in snap operation and starts at block 301. Prior to performing the process 300, a firs setpoint value and a second setpoint value are set for the controller output signal, a threshold snap cycle time is set for comparison with the timer value, and a snap cycle threshold number is set for comparison with the number of snap cycles that is tracked by the process 300. The equipment operates in two conditions or positions based on the controller output signal in snap operation.

At block 301 the number of snap cycles is set to zero. The process 300 then proceeds to block 302.

At block 302, the timer of the liquid level controller 11 is set to zero. The process 300 then proceeds to block 303.

At block 303, the liquid level controller 11 reads the controller output signal (COS). To read the COS, the liquid level controller 11 can include an analog to digital converter (ADC) connected to the communication line 8 or part of the electronic circuit board 28 that has the controller output signal. The ADC can receive the controller output signal as an input, that is then converted to a digital value for use in the process 300 by the liquid level controller 11.

At decision block 304, the liquid level controller 11 determines whether the COS is equal to a first setpoint signal value. The first setpoint signal value can be a maximum setpoint value. For example, if the controller output signal is a current for a 12V or 24V electrical signal, the first setpoint signal value (e.g., the maximum setpoint value) can be 20 mA. An answer to the decision block 304 of “no” causes the process 300 to proceed to decision block 305. An answer to the decision block 304 of “yes” is indicative that the actuated valve 7 is in the open position, and the process 300 proceeds to decision block 307.

At decision block 305, the liquid level controller 11 determines whether the COS is equal to a second setpoint signal value. The second setpoint signal value can be a minimum setpoint value. For example, if the controller output signal is a current for a 12V or 24V electrical signal, the second setpoint signal value (e.g., the minimum setpoint value) can be 4 mA. An answer to the decision block 305 of “yes” is indicative that the actuated valve 7 is in the closed position, and the process 300 proceeds to decision block 306. An answer to the decision block 305 of “no” causes the process to flow back to block 303, and then through decision block 304 as already described.

At decision block 306, the liquid level controller 11 determines whether the time value is greater than a threshold snap cycle time. An answer to the decision block 306 of “yes” causes the process 300 to flow back to block 301. An answer to the decision block 306 of “no” causes the process 30 to flow back to block 303.

At decision block 307, the liquid level controller 11 determines whether the timer is running. An answer to the decision block 307 of “yes” causes the process 300 to flow to decision block 309. An answer to the decision block 307 of “no” causes the process 300 to proceed to block 308.

At block 308, the liquid level controller 11 starts the timer. The process 300 then proceeds to decision block 309.

At decision block 309, the liquid level controller 11 determines whether a timer interrupt condition is true. “Timer interrupt condition” can be a condition that causes the process 300 to flow to decision block 310 if true and back to block 303 if not true. For example, the condition could be that a predetermined amount of time has passed, such as 100 seconds, as measured by the timer function in the background while process 300 is performed. An answer to the decision block 309 of “yes” causes the process 300 to flow to decision block 310. An answer to the decision block 309 of “no” causes the process 300 to flow back to block 303.

At decision block 310, the liquid level controller 11 determines whether the timer value is less than a threshold snap cycle time value. An answer to decision block 310 of “no” causes the process 300 to flow back to block 302. An answer to decision block 310 of “yes” causes the process 300 to flow to block 311. Examples of a threshold snap cycle time (or threshold snap cycle time value) can be any time value such as but not limited to 0.1, 0.2, 0.3, 0.4, 0.5, 0.6, 0.7, 0.8, 0.9, 1, 2, 3, 4, 5, 6, 7, 8, 9, 10, 15, 20, 25, 30, 35, 40, 45, 50, 55, or 60 minutes.

At block 311, the liquid level controller 11 increments the number of snap cycles to add a snap cycle to the existing number of snap cycles tracked by the liquid level controller 11. For example, for a process 300 that begins at block 301 and arrives to block 311, the number of snap cycles is incremented from zero to one. Process 300 then flows to decision block 312.

At decision block 312, the liquid level controller 11 determines whether the number of snap cycles is equal to a threshold number of snap cycles. An answer to decision block 312 of “no” causes the process 300 to flow back to block 302. An answer to decision block 312 of “yes” causes the liquid level controller 11 to change from snap operation to throttle operation.

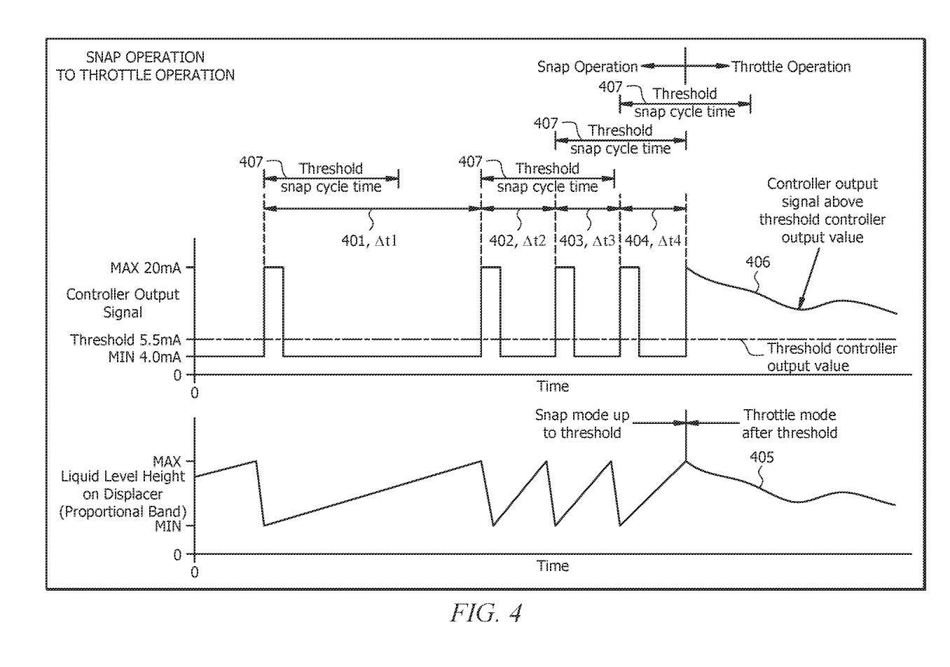

FIG. 4 illustrates graphs of liquid level in the vessel and controller output signal versus time, for determining when to switch the liquid level controller from snap operation to throttle operation during snap operation of a liquid level controller. Switching from snap operation to throttle operation is determined by comparing the time period of each snap cycle time for a set number of consecutive snap cycles to a threshold snap cycle time. In FIG. 4, the setpoint number of consecutive snap cycles is three. If three consecutive snap cycles have a snap cycle time that is below the threshold snap cycle time, then the liquid level controller 11 changes itself from snap operation to throttle operation.

FIG. 4 illustrates four snap cycles: a first snap cycle 401, a second snap cycle 402, a third snap cycle 403, and a fourth snap cycle 404. Snap cycles 401, 402, 403, and 404 occur as described for snap cycles 115, 116, and 117 in FIG. 2A, which are based on the liquid flow rate into the vessel 1 over time (and changes in liquid flow rate over time) and the changes in the height of the displacer 12 of the liquid level controller 11 in response to the changes in liquid levels in the vessel 1.

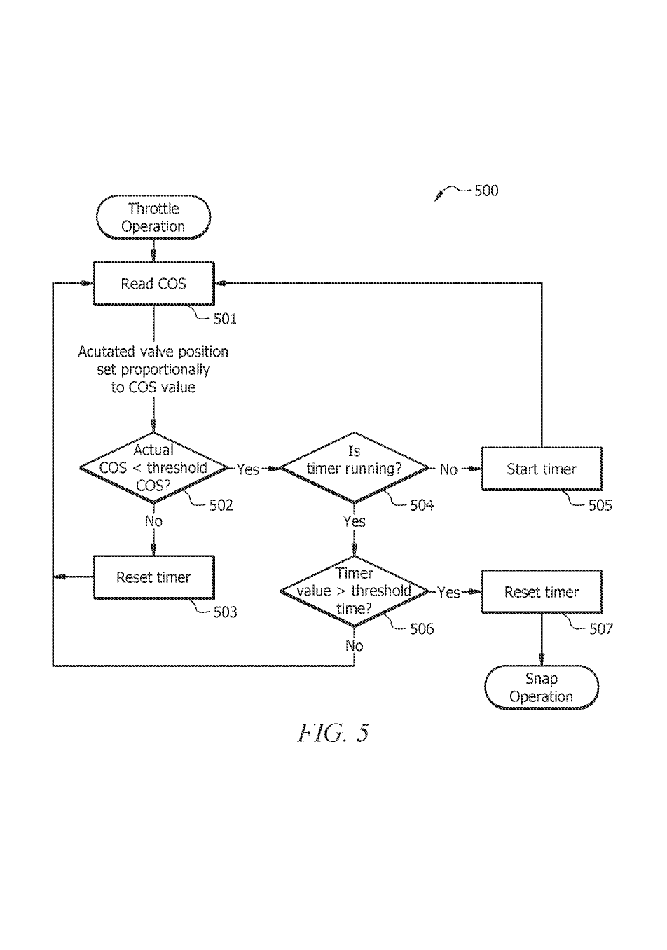

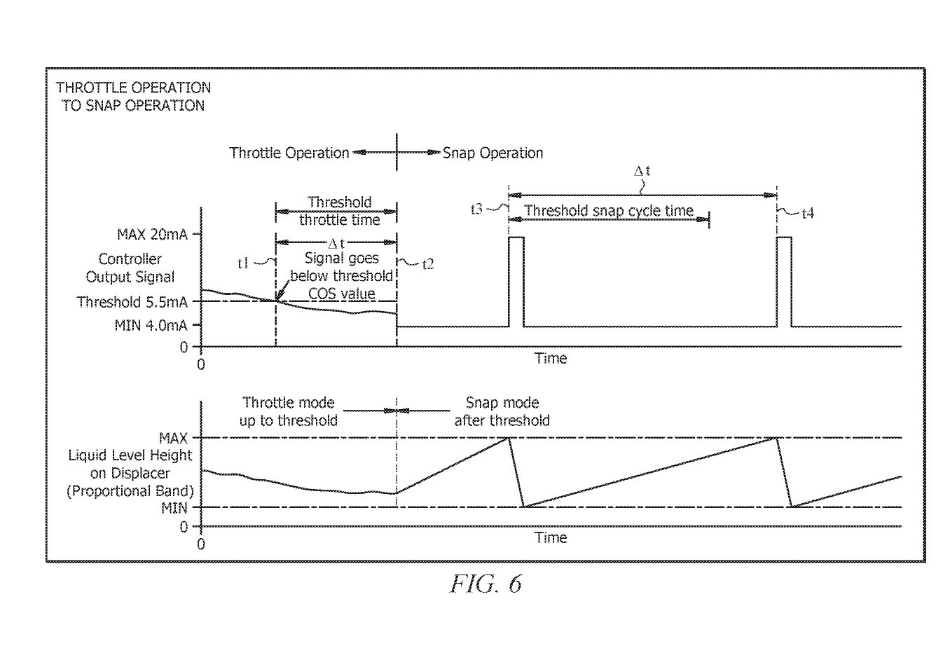

The snap cycle time Δt1 of the first snap cycle 401, the snap cycle time Δt2 for the second snap cycle 402, the snap cycle time Δt3 for the third snap cycle 403, and the snap cycle time Δt4 for the fourth snap cycle 404 are measured by the timer function of the liquid level controller 11. Each snap cycle time Δt1, Δt2, Δt3, and Δt4 is compared to the threshold snap cycle time 407. As illustrated in FIG. 4, the snap cycle time Δt1 for the first snap cycle 401 is greater than the threshold snap cycle time 407. The number of incremented snaps in process 300 remains zero after first snap cycle 401. The snap cycle time Δt2 for the second snap cycle 402 is less than the threshold snap cycle time 407, so the liquid level controller 11 increments the number of snap cycles that have occurred below the threshold to one. The liquid level controller 11 then resets the timer to zero. The snap cycle time Δt3 for the third snap cycle 403 is also less than the threshold snap cycle time 407, so the liquid level controller 11 increments the number of snap cycles that have occurred below the threshold to two. If the snap cycle time Δt3 had been above the threshold, then the liquid level controller 11 would have resent the number of cycles to zero and the timer to zero, and the process 300 starts again at block 301. The snap cycle time Δt4 for the fourth snap cycle 404 is also less than the threshold snap cycle time 407, so the liquid level controller 11 increments the number of snap cycles that have occurred below the threshold to three. In the process 300, the answer to decision block 312 is “yes,” so the liquid level controller 11 switches from snap operation to throttle operation, which is indicated by the curve of displacer height 405 and curve of the controller outlet signal 406. Throttle operation is conducted as described for FIG. 2B, FIG. 5, and FIG. 6. As is explained in more detail herein, throttle operation is maintained until the controller output signal drops below a threshold controller output value for a setpoint period of time.

For the operation in FIG. 4, the threshold number of consecutive snap cycles that can fall below the threshold snap cycle time is three; however, it is contemplated that any number of consecutive snap cycles can be utilized, depending on the application. In aspects, having a threshold number of consecutive snap cycles to be three or more can account for anomaly snap cycles and prevent undesired switching from snap operation to throttle operation. Changing from snap operation to throttle operation as described herein can reduce or eliminate the problematic issues that occur with excessively short snap cycle times that result in high cycle wear and damage in electric actuation and actuated valve trim, seals, or packing. Trim is defined as the internal port of valve, including the plug and the seat of the valve.

FIG. 5 illustrates a flowchart of a process 500 for switching a liquid level controller from throttle operation to snap operation. To perform the process 500, the liquid level controller 11 is operable to read the controller output signal (e.g., via an analog to digital converter of the controller 11), keep track of time with a timer function, and analyze the timer value versus a stored threshold throttle time. The process 500 takes place while the liquid level controller 11 is in throttle operation and starts at block 501. Prior to performing the process 500, a threshold controller output value and a threshold throttle time are set.

At block 501, the liquid level controller 11 reads the controller output signal (COS). The read COS can also be referred to as the actual controller output signal or actual COS. To read the actual COS, the liquid level controller 11 can include an analog to digital converter (ADC) connected to the communication line 8 or part of the electronic circuit board 28 that has the controller output signal. The ADC can receive the controller output signal as an input, that is then converted to a digital value for use in the process 300 by the liquid level controller 11. The actual controller output signal is indicative of the actuated valve position that is set by the liquid level controller 11 in throttle operation to be proportional to the COS value. The process 500 then proceeds to decision block 502.

At decision block 502, the liquid level controller 11 determines whether the actual COS value is greater than the threshold COS value. An answer to decision block 502 of “no” causes the process 500 to flow to block 503. An answer to decision block 502 of “yes” causes the process 500 to flow to decision block 504.

At block 503, the liquid level controller 11 resets the time value to zero. Flow then proceeds to block 501.

At decision block 504, the liquid level controller 11 determines whether the timer is running. An answer to decision block 504 of “no” causes the process 500 to flow to block 505. An answer to decision block 504 of “yes” causes the process 500 to flow to decision block 506.

At block 505, the liquid level controller 11 starts the timer function. Flow then proceeds back to block 501.

At decision block 506, the liquid level controller 11 determines whether the timer value is greater than the threshold throttle time. An answer to decision block 506 of “no” causes the process 500 to flow to block 501. An answer to decision block 506 of “yes” causes the process 500 to flow to block 507.

At block 507, the liquid level controller 11 resets the timer to zero. After block 507, the liquid level controller 11 then changes from throttle operation to snap operation.

FIG. 6 illustrates graphs of liquid level in the vessel and controller output signal versus time, for determining when to switch the liquid level controller from snap operation to throttle operation during throttle operation of a liquid level controller. While the scope of this disclosure includes any threshold controller output signal value between the low setpoint value and the high setpoint value for the controller (the threshold controller output signal value is equal to or greater than the low setpoint value and equal to or less than the high setpoint value), the exemplary threshold controller output signal value in FIG. 6 is set at 5.5 mA (which is between the high setpoint value of 20 mA and the low setpoint value of 4 mA), for purposes of description. In aspects, the threshold controller output signal value is selected so that the equipment (e.g., actuated valve or pump) being controlled does not operate at less than about 10, 9, 8, 7, 6, 5, 4, 3, 2, or 1% of total actuated valve travel or pump capacity, which can greatly improve the useful life of the equipment. The equipment operates in two conditions or positions and at conditions or positions between the two, based on the controller output signal in throttle operation.

Throttle operation occurs similarly as described for FIG. 2B from time = 0 to time t1 in FIG. 6. At time t1, the actual controller output signal value is below the threshold controller output signal value. The liquid level controller 11 reads the actual controller output signal value and begins tracks how much time the actual controller output signal is below the threshold throttle time. In FIG. 4, the time period Δt that the actual controller output signal extends to the threshold throttle time, so the answer to decision block 506 in process 500 is “yes,” and the liquid level controller 11 resets the timer to zero and automatically switches the liquid level controller 11 from throttle operation to snap operation. Snap operation is conducted as described for FIG. 2A and FIG. 3, and snap cycle times are then monitored as described for FIG. 3 and FIG. 4. If the actual controller output signa had risen above the threshold controller output value signal prior to elapse of the threshold throttle time, the answer to decision block 506 in process 500 would have been ”no,” and the process 500 would have flowed back to block 501.

It was found that comparing the time period Δt that the actual controller output signal persists below the threshold controller output signal value to the threshold throttle time can reduce or eliminate unwanted or unintended transitions from throttle operation to snap operation, for example, unintended due to signal variability resulting from equipment vibration or signal noise.

### ADDITIONAL DESCRIPTION

Aspect 1. A controller comprising: a sensor; and a control unit having an electronic circuit board coupled to the sensor, wherein the electronic circuit board is electrically connected to an equipment, wherein the electronic circuit board has a processor and memory with instructions stored thereon which cause the processor to control the equipment based on an electrical signal received from the sensor, wherein instructions further causes the processor of the electronic circuit board of the control unit to: operate in a snap operation or a throttle operation for control of the equipment; and one or both of: switch from the snap operation to the throttle operation upon determining a setpoint number of consecutive snap cycles for the equipment each have an actual snap cycle time that is less than a threshold snap cycle time, and switch from the throttle operation to the snap operation upon determining an actual controller output signal to the equipment is less than a threshold controller output signal value for a period of time that is equal to or greater than a threshold throttle time.

Aspect 2. The controller of Aspect 1, wherein the sensor comprises: a displacer; an arm, wherein the displacer is coupled to an end of the arm; a force balance assembly coupled to an opposite end of the arm; and a load cell having an input pin that contacts the force balance assembly, wherein the load cell is electrically connected to the electronic circuit board.

Aspect 3. The controller of Aspect 1 or 2, wherein the sensor comprises a capacitive sensor, an electro-optic sensor, an ultrasonic sensor, or a combination thereof.

Aspect 4. The controller of any one of Aspects 1 to 3, wherein the equipment is an actuated valve.

Aspect 5. The controller of any one of Aspects 1 to 4, wherein the setpoint number of consecutive snap cycles is three or more.

Aspect 6. The controller of any one of Aspects 1 to 5, wherein the threshold snap cycle time is 0.1, 0.2, 0.3, 0.4, 0.5, 0.6, 0.7, 0.8, 0.9, 1, 2, 3, 4, 5, 6, 7, 8, 9, 10, 15, 20, 25, 30, 35, 40, 45, 50, 55, or 60 minutes.

Aspect 7. The controller of any one of Aspects 1 to 6, wherein the threshold controller output signal value is greater than a minimum controller output signal of the control unit.

Aspect 8. The controller of any one of Aspects 1 to 7, wherein the snap operation utilizes a maximum controller output signal and a minimum controller output signal to control the equipment between a first position or state and a second position or state.

Aspect 9. The controller of any one of Aspects 1 to 8, wherein the throttle operation utilizes an intermediate controller output signal to control the equipment to an intermediate position or state that is between a first position or state and a second position or state.

Aspect 10. The controller of any one of Aspects 1 to 9, wherein the control unit outputs a controller output signal to the equipment during the snap operation and the throttle operation for control of the equipment.

Aspect 11. A process comprising: controlling, by a controller while in a snap operation, an equipment that is coupled to a vessel; and switching, by the controller, from the snap operation to a throttle operation upon determining a setpoint number of consecutive snap cycles for the equipment each have an actual snap cycle time that is less than a threshold snap cycle time.

Aspect 12. The process of Aspect 11, further comprising: after switching, controlling, by the controller while in the throttle operation, the equipment.

Aspect 13. The process of Aspect 11 or 12, further comprising: switching, by the controller, from the throttle operation to the snap operation upon determining an actual controller output signal to the equipment is less than a threshold controller output signal value for a period of time that is equal to or greater than a threshold throttle time.

Aspect 14. The process of any one of Aspects 11 to 13, wherein the equipment is an actuated valve.

Aspect 15. The process of any one of Aspects 11 to 14, wherein the controller does not operate pneumatically.

Aspect 16. A process comprising: controlling, by a controller in a throttle operation, an equipment that is coupled to a vessel; and switching, by the controller, from the throttle operation to a snap operation upon determining an actual controller output signal to the equipment is less than a threshold controller output signal value for a period of time that is equal to or greater than a threshold throttle time.

Aspect 17. The process of Aspect 16, further comprising: after switching, controlling, by the controller while in the snap operation, the equipment.

Aspect 18. The process of Aspect 16 or 17, further comprising: switching, by the controller, from the snap operation to the throttle operation upon determining a setpoint number of consecutive snap cycles for the equipment each have a snap cycle time that is less than a threshold snap cycle time.

Aspect 19. The process of Aspect 18, wherein the equipment is an actuated valve.

Aspect 20. The process of any one of Aspects 16 to 19, wherein the controller does not operate pneumatically.

Aspect 21. An apparatus comprising: a vessel, a controller coupled to the vessel, and an equipment fluidly coupled to the vessel and electronically coupled to the controller; wherein the controller includes a sensor connected to the vessel and a control unit having an electronic circuit board coupled to the sensor, wherein the electronic circuit board is electrically connected to the equipment, wherein the electronic circuit board has a processor and memory with instructions stored thereon which cause the processor to control the equipment based on an electrical signal received from the sensor, wherein the instructions further causes the processor of the electronic circuit board of the control unit to: operate in a snap operation or a throttle operation for control of the equipment; and one or both of: switch from the snap operation to the throttle operation upon determining a setpoint number of consecutive snap cycles for the equipment each have an actual snap cycle time that is less than a threshold snap cycle time, and switch from the throttle operation to the snap operation upon determining an actual controller output signal to the equipment is less than a threshold controller output signal value for a period of time that is equal to or greater than a threshold throttle time.

Aspect 22. The apparatus of Aspect 21, controller wherein the sensor comprises: a displacer; an arm, wherein the displacer is coupled to an end of the arm; a force balance assembly coupled to an opposite end of the arm; and a load cell having an input pin that contacts the force balance assembly, wherein the load cell is electrically connected to the electronic circuit board.

Aspect 23. The apparatus of Aspect 21 or 22, wherein the sensor comprises a capacitive sensor, an electro-optic sensor, an ultrasonic sensor, or a combination thereof.

Aspect 24. The apparatus of any one of Aspects 21 to 23, wherein the equipment is an actuated valve.

Aspect 25. The apparatus of any one of Aspects 21 to 24, wherein the setpoint number of consecutive snap cycles is three or more.

Aspect 26. The apparatus of any one of Aspects 21 to 25, wherein the threshold snap cycle time is 0.1, 0.2, 0.3, 0.4, 0.5, 0.6, 0.7, 0.8, 0.9, 1, 2, 3, 4, 5, 6, 7, 8, 9, 10, 15, 20, 25, 30, 35, 40, 45, 50, 55, or 60 minutes.

Aspect 27. The apparatus of any one of Aspects 21 to 26, wherein the threshold controller output signal value is greater than a minimum controller output signal of the control unit.

Aspect 28. The apparatus of any one of Aspects 21 to 27, wherein the snap operation utilizes a maximum controller output signal and a minimum controller output signal to control the equipment between a first position or state and a second position or state.

Aspect 29. The apparatus of any one of Aspects 21 to 28, wherein the throttle operation utilizes an intermediate controller output signal to control the equipment to an intermediate position or state that is between a first position or state and a second position or state.

Aspect 30. The apparatus of any one of Aspects 21 to 29, wherein the control unit outputs a controller output signal to the equipment during the snap operation and the throttle operation for control of the equipment.

Although the present disclosure and its advantages have been described in detail, it should be understood that various changes, substitutions, and alterations can be made herein without departing from the spirit and scope of the disclosure as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A controller comprising:
a sensor; and
a control unit having an electronic circuit board coupled to the sensor, wherein the electronic circuit board is electrically connected to an equipment, wherein the electronic circuit board has a processor and memory with instructions stored thereon which cause the processor to control the equipment based on an electrical signal received from the sensor,
wherein instructions further causes the processor of the electronic circuit board of the control unit to:
operate in a snap operation or a throttle operation for control of the equipment; and
one or both of:
switch from the snap operation to the throttle operation upon determining a setpoint number of consecutive snap cycles for the equipment each have an actual snap cycle time that is less than a threshold snap cycle time, and
switch from the throttle operation to the snap operation upon determining an actual controller output signal to the equipment is less than a threshold controller output signal value for a period of time that is equal to or greater than a threshold throttle time.

2. The controller of claim 1, wherein the sensor comprises:
a displacer;
an arm, wherein the displacer is coupled to an end of the arm;
a force balance assembly coupled to an opposite end of the arm; and
a load cell having an input pin that contacts the force balance assembly,
wherein the load cell is electrically connected to the
electronic circuit board.

3. The controller of claim 1, wherein the sensor comprises a capacitive sensor, an electro-optic sensor, an ultrasonic sensor, or a combination thereof.

4. The controller of claim 1, wherein the equipment is an actuated valve.

5. The controller of claim 1, wherein the setpoint number of consecutive snap cycles is three or more.

6. The controller of claim 1, wherein the threshold snap cycle time is 0.1, 0.2, 0.3, 0.4, 0.5, 0.6, 0.7, 0.8, 0.9, 1, 2, 3, 4, 5, 6, 7, 8, 9, 10, 15, 20, 25, 30, 35, 40, 45, 50, 55, or 60 minutes.

7. The controller of claim 1, wherein the threshold controller output signal value is greater than a minimum controller output signal of the control unit.

8. The controller of claim 1, wherein the snap operation utilizes a maximum controller output signal and a minimum controller output signal to control the equipment between a first position or state and a second position or state.

9. The controller of claim 1, wherein the throttle operation utilizes an intermediate controller output signal to control the equipment to an intermediate position or state that is between a first position or state and a second position or state.

10. The controller of claim 1, wherein the control unit outputs a controller output signal to the equipment during the snap operation and the throttle operation for control of the equipment.

11. A process comprising:
controlling, by a controller while in a snap operation, an equipment that is coupled to a vessel; and
switching, by the controller, from the snap operation to a throttle operation upon determining a setpoint number of consecutive snap cycles for the equipment each have an actual snap cycle time that is less than a threshold snap cycle time.

12. The process of claim 11, further comprising:
after switching, controlling, by the controller while in the throttle operation, the equipment.

13. The process of claim 11, further comprising:
switching, by the controller, from the throttle operation to the snap operation upon determining an actual controller output signal to the equipment is less than a threshold controller output signal value for a period of time that is equal to or greater than a threshold throttle time.

14. The process of claim 11, wherein the equipment is an actuated valve.

15. The process of claim 11, wherein the controller does not operate pneumatically.

16. A process comprising:
controlling, by a controller in a throttle operation, an equipment that is coupled to a vessel; and
switching, by the controller, from the throttle operation to a snap operation upon determining an actual controller output signal to the equipment is less than a threshold controller output signal value for a period of time that is equal to or greater than a threshold throttle time.

17. The process of claim 16, further comprising:
after switching, controlling, by the controller while in the snap operation, the equipment.

18. The process of claim 16, further comprising:
switching, by the controller, from the snap operation to the throttle operation upon determining a setpoint number of consecutive snap cycles for the equipment each have a snap cycle time that is less than a threshold snap cycle time.

19. The process of claim 18, wherein the equipment is an actuated valve.

20. The process of claim 16, wherein the controller does not operate pneumatically.

21. An apparatus comprising:
a vessel, a controller coupled to the vessel, and an equipment fluidly coupled to the vessel and electronically coupled to the controller;
wherein the controller includes a sensor connected to the vessel and a control unit having an electronic circuit board coupled to the sensor, wherein the electronic circuit board is electrically connected to the equipment,
wherein the electronic circuit board has a processor and memory with instructions stored thereon which cause the processor to control the equipment based on an electrical signal received from the sensor, wherein the instructions further causes the processor of the electronic circuit board of the control unit to:
operate in a snap operation or a throttle operation for control of the equipment; and
one or both of:
switch from the snap operation to the throttle operation upon determining a setpoint number of consecutive snap cycles for the equipment each have an actual snap cycle time that is less than a threshold snap cycle time, and
switch from the throttle operation to the snap operation upon determining an actual controller output signal to the equipment is less than a threshold controller output signal value for a period of time that is equal to or greater than a threshold throttle time.
